(19) United States
(12) Patent Application Publication
(10) Pub. No.: US 2019/0094360 A1
(43) Pub. Date: Mar. 28, 2019

(54) LASER RANGING DEVICE, IMAGE-CAPTURING APPARATUS, AND TERMINAL

(71) Applicant: GIONEE COMMUNICATION EQUIPMENT CO.,LTD. SHENZHEN, Shenzhen (CN)

(72) Inventor: Xiaofeng HUANG, Shenzhen (CN)

(73) Assignee: GIONEE COMMUNICATION EQUIPMENT CO.,LTD. SHENZHEN, Shenzhen (CN)

(21) Appl. No.: 15/539,830

(22) PCT Filed: Aug. 23, 2016
(86) PCT No.: PCT/CN2016/096364

§ 371 Date: Jun. 26, 2017

(30) Foreign Application Priority Data
Jan. 18, 2016 (CN) 201610032685.7

(51) Int. Cl. G01S 17/08; G01S 7/481; G03B 13/20; H04N 5/225

(52) U.S. Cl. CPC G01S 17/08; H04N 5/2251; G03B 13/20; G01S 7/481

(57) ABSTRACT

A laser ranging device, an image-capturing apparatus, and a terminal is disclosed by the present disclosure. The laser ranging device includes a housing, a laser ranging sensor, and a cover plate. The housing is provided with a light-transmitting window. The laser ranging sensor is mounted in the housing. A light emitter and a light receiver are provided separately in the laser ranging sensor. The light emitter emits a light beam to the detected object through the cover plate. The light beam is reflected to the light receiver through the cover plate by the detected object and is received by the light receiver. The cover plate is embedded in the light-transmitting window. The light-blocking member is provided between the cover plate and the light-transmitting window.

### CROSS REFERENCE TO RELATED APPLICATIONS

The present application claims priority to Chinese Patent Application No. 201610032685.7, filed with the Chinese Patent Office on Jan. 18, 2016 and entitled “LASER RANGING DEVICE, IMAGE-CAPTURING APPARATUS, AND TERMINAL”, the content of which is hereby incorporated by reference in its entirety.

### TECHNICAL FIELD

The present disclosure relates to optics, and more particularly, to a laser ranging device, an image-capturing apparatus, and a terminal.

### BACKGROUND

Near-infrared laser ranging technology can quickly measure a distance from a detected object to a sensor, based on TOF (time of fly) of a photon. A laser ranging sensor can measure a target distance based on the TOF from emission of the photon to the receipt of the photon by emitting and receiving near-infrared light. When the ranging technology is applied to a terminal having a photographing function, such as a mobile phone, an auto focusing speed is increased with the distance information, so as to have better photographing experience.

Currently, since generally the laser ranging sensor should emit and receive the near-infrared light, an optical window should generally be provided in the housing of the terminal, and a light-transmitting cover plate is generally provided on the surface of the optical window so as to seal the optical window. Meanwhile, the light-transmitting cover plate enables a light emitter of the laser ranging sensor to emit light to the detected object. The light is reflected to a light receiver through the optical window by the detected object and is received by the light receiver, so as to achieve a purpose that the target distance is measured. However, when the light emitted from the light emitter is directly reflected to the light receiver by the inside of a housing, the light readily causes crosstalk for the infrared light, thereby rendering result of measuring the target distance less accurate, thus failing to produce an effect that the auto focusing speed is increased.

### SUMMARY

A laser ranging device according to the implementation of the present disclosure can prevent the crosstalk for the infrared light caused by the reflected light, and ensure the accuracy of the result of measuring the target distance.

According to a first aspect of the present disclosure, a laser ranging device is provided. The laser ranging device includes a housing, a laser ranging sensor, and a cover plate. The housing is provided with a light-transmitting window. The laser ranging sensor is mounted in the housing. A light emitter and a light receiver are provided separately in the laser ranging sensor. The light emitter emits a light beam to the detected object through the light-transmitting window. The light beam is reflected to the light receiver through the light-transmitting window by the detected object and is received by the light receiver. The cover plate is embedded in the light-transmitting window. The light-blocking member is provided between the cover plate and the light-transmitting window.

According to a second aspect of the present disclosure, an image-capturing apparatus is provided. The image-capturing apparatus includes a camera assembly, a processor, and the foregoing laser ranging device. The processor is electrically connected to the camera assembly. The laser ranging device is electrically connected to the processor. The laser ranging device sends a measurement result to the processor. The processor feeds the measurement result back to the camera assembly such that the camera assembly receives the measurement result and performs focusing for capturing images.

According to a third aspect of the present disclosure, a terminal is provided. The terminal includes a main board and the foregoing laser ranging device. The main board is provided in the housing of the laser ranging device, and the laser ranging sensor of the laser ranging device is electrically connected to the main board.

According to the laser light-intercepting device, the image-capturing apparatus, and the terminal of the present disclosure, the light-blocking member is provided between the cover plate and the light-transmitting window, and the light emitted from the light emitter to the edge of the cover plate or the inner surface of the housing can be blocked by the light-blocking member, thereby preventing the light from being directly reflected to the light receiver by the edge of the cover plate or the inner surface of the housing and from being absorbed by the light receiver to cause crosstalk for the emission and receipt of the infrared light, and ensuring the accuracy of the result of the laser ranging sensor measuring the target distance.

### BRIEF DESCRIPTION OF DRAWINGS

In order to more clearly describe technical solutions of the present disclosure, accompanying drawings used in the implementations will be briefly introduced hereinafter. Apparently, the accompanying drawings described hereinafter show some implementations of the present disclosure, and persons skilled in the art may also derive other drawings from these accompanying drawings without creative efforts.

FIG. 1 is a schematic view of a sectional structure of a laser ranging device according to a first implementation of the present disclosure.

FIG. 2 is a schematic view of a sectional structure of a laser ranging device according to a second implementation of the present disclosure.

FIG. 3 is a schematic view of the sectional structure as illustrated in FIG. 2 omitting a light-blocking member.

FIG. 4 is a schematic view of another sectional structure of the laser ranging device according to the second implementation of the present disclosure.

FIG. 5 is a schematic exploded view of a sectional structure of a laser ranging device according to a third implementation of the present disclosure.

FIG. 6 is a schematic exploded view of another sectional structure of the laser ranging device according to the third implementation of the present disclosure.

FIG. 7 is a schematic exploded view of a sectional structure of a laser ranging device according to a fourth implementation of the present disclosure.

### DETAILED DESCRIPTION

A clear, complete description for the technical solutions of implementations of the present disclosure is provided below, in conjunction with the drawings in the implementations of the present disclosure. Apparently, the implementations to be described are a part of rather than all implementations of the present disclosure. All other implementations obtained by persons skilled in the art from the implementations given herein without creative efforts should fall within the protection scope of the present disclosure.

For convenience of description, spatially relative terms, such as “under”, “below”, “down”, “above”, “up”, and so on, may be used herein to describe relationship between an element or feature and another (other) element(s) or feature(s) as illustrated in the drawings. It should be understood that, when an element or layer is “on” or “connected to” or “coupled to” another element or layer as stated, it may be on or connected to or coupled to another element or layer, directly or via an intermediate element or layer.

It should be understood that the terms used herein are for describing particular implementations only and are not intended to be limiting of the present disclosure. As used herein, the singular forms “a”, “an” and “the” are intended to include the plural forms as well, unless the context clearly indicates otherwise. Furthermore, the terms “comprises”, “comprising”, “includes” and/or “including”, when used herein, specify the presence of stated features, integers, steps, operations, elements, and/or components, but do not preclude the presence or addition of one or more other features, integers, steps, operations, elements, components, and/or groups thereof. What is described hereinafter is typical implementations of the present disclosure, however, this description is for the purpose of describing general principles of the present disclosure, and is not intended to limit the scope of the present disclosure. The protection scope of the present disclosure should be subject to the protection scope defined in the appended claims.

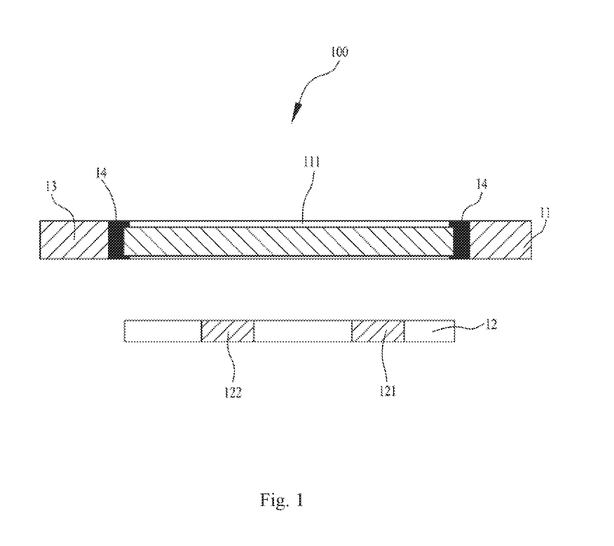

FIG. 1 illustrates a laser ranging device 100 according to a first implementation of the present disclosure. The laser ranging device 100 includes a housing 11, a laser ranging sensor 12, and a cover plate 13. The housing 11 is provided with a light-transmitting window 111. The laser ranging sensor 12 is mounted in the housing 11. A light emitter 121 and a light receiver 122 are provided separately in the laser ranging sensor 12. The light emitter 121 emits a light beam to the detected object through the light-transmitting window 111, and the light beam is reflected to the light receiver 122 through the light-transmitting window 111 by the detected object and is received by the light receiver 122. The cover plate 13 is embedded in the light-transmitting window 111, and a light-blocking member 14 is provided between the cover plate 13 and the light-transmitting window 111.

In this implementation, the housing 11 is a metal hosing, and the housing 11 may be a housing of a terminal or a housing of an image-capturing apparatus. The housing 11 is provided with the light-transmitting window 111, and the light-transmitting window 111 has a shape identical with that of the cover plate 13 so as to facilitate the mounting of the cover plate 13. Typically, the light-transmitting window 111 may be a U-shaped groove, so that the laser ranging device 100 has a fine appearance. In addition, the position on the outer surface of the housing 11 where the light-transmitting window 111 is provided is a circular transition, so that the user can have a fine and comfortable touch feeling when using it.

In this implementation, the cover plate 13 is made of optical glass material. The cover plate 13 is a square plate or a U-shaped plate. The light emitter 121 emits the light beam through the cover plate 13 and emits to the detected object through the light-transmitting window 111. Then, the light beam is reflected to the light receiver 122 through the light-transmitting window 111 and the cover plate 13 by the detected object, and is received by the light receiver 122. The time when the light beam is emitted, reaches the detected object, goes back, and is received by the light receiver 122 is recorded and processed, thereby achieving a purpose that the target distance is measured.

The light-blocking member 14 is provided between the cover plate 13 and the light-transmitting window 111. In this implementation, the light-blocking member 14 may be a light-blocking gasket, a light-blocking seal, or a light-absorbing adhesive, so that when the cover plate 13 is embedded in the light-transmitting window 111, the light-blocking member 14 can be tightly pressed between the cover plate 13 and the light-transmitting window 111. Therefore, when the light emitter 121 emits light to the periphery of the cover plate 13 or the interior wall of the light-transmitting window 111, the light can be prevented from being reflected to the light receiver 122 directly through the periphery of the cover plate 13 or the interior wall of the light-transmitting window 111 and being received by the light receiver 122 to cause crosstalk for the infrared light, due to the light-blocking effect of the light-blocking member 14. In addition, since the light-blocking member 14 is a light-blocking gasket, a light-blocking seal, a light-absorbing adhesive, or the like, the light-blocking member 14 can further ensure the connection tightness between the cover plate 13 and the light-transmitting window 111, thereby preventing dust or water from entering the inside of the housing 11 through the light-transmitting window 111, enhancing waterproof and dustproof performance of the laser ranging device 100.

In the laser ranging device 100 according to the first implementation of the present disclosure, the light-blocking member 14 is configured to be a light-blocking gasket, a light-blocking seal, or a light absorbing adhesive, thereby being capable of preventing the light emitted to both ends of the cover plate 13 by the light emitter 121 from being reflected to the light receiver 122 directly by the both ends of the cover plate 13, and in turn avoiding causing crosstalk for the light receiver 122 when it receives the infrared light. In addition, since the light-blocking member 14 has a fine light-blocking property, the light-blocking effect of the light-blocking member 14 can be further ensured. In the meanwhile, since the light-blocking member 14 has a fine waterproof and dustproof property, the waterproof and dustproof performance of the laser ranging device 100 can be greatly enhanced.

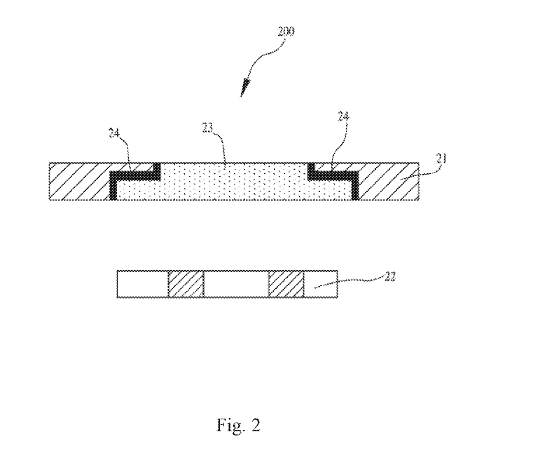

FIGS. 2 to 4 are schematic views of a structure of a laser ranging device 200 according to a second implementation of the present disclosure. The laser ranging device 200 includes a housing 21, a laser ranging sensor 22 provided in the housing, and a cover plate 23 provided above the laser ranging sensor 22. The housing 21 is provided with a light-transmitting window 211. The cover plate 23 is embedded in the light-transmitting window 211, and a light-blocking member 24 is provided between the cover plate 23 and the light-transmitting window 211.

The laser ranging device 200 according to the second implementation of the present disclosure differs from the laser ranging device 100 according to the first implementation in the following.

The cover plate 23 includes an engaging portion 231 and a bearing portion 232 which are arranged up and down. The light-transmitting window 211 is a stepped groove formed in the housing 21. And the light-transmitting window 211 includes a first step groove 211a, a second step groove 211b, and a connection surface 211c connected between the first step groove 211a and the second step groove 211b. The engaging portion 231 is embedded in the first step groove 211a, and the bearing portion 232 is embedded in the second step groove 211b.

In this implementation, the cover plate 23 is an integrally molded inverted T-shaped structure. The engaging portion 231 is embedded in the first step groove 211a, that is to say, a gap may be provided between the engaging portion 231 and the first step groove 211a, or the engaging portions 231 and the first step groove 211a are configured to be attached to each other face to face, i.e., gapless attachment. When the gap is provided between the engaging portion 231 and the first step groove 211a, the light-blocking member 24 may be located in the gap between the groove wall of the first step groove 211a and the engaging portion, so as to fill the gap. Typically, the light-blocking member 24 may be a light-blocking gasket, a light-blocking seal, a light-absorbing adhesive, or the like. The gap between the engaging portion 231 and the first step groove 211a is filled with the light-blocking member 24, thereby achieving the waterproof and dustproof performance, and being capable of absorbing the light emitted to between the engaging portion 231 and the first step groove 211a, in turn preventing the light from being reflected on the light receiver of the laser ranging sensor 22.

Furthermore, since the bearing portion 232 is embedded in the second step groove 211b, the bearing portion 232 and the second step groove 211b may be gaplessly attached or a gap may be provided therebetween. When a gap is provided between the bearing portion 232 and the second step groove 211b, the light-blocking member 24 may be located in the gap between the groove wall of the second step groove 211b and the bearing portion 232, so as to fill the gap between the bearing portion 232 and the second step groove 211b, thereby connecting the bearing portion 232 to the second step groove 211b, and being capable of absorbing the light emitted to between the bearing portion 232 and the second step groove 211b. Typically, the light-blocking member 24 may be a light-blocking gasket, a light-blocking seal, a light-absorbing adhesive, or the like.

Furthermore, the bottom of the bearing portion 232 is configured to be parallel with the connection surface 211c, and a gap is provided between the bottom of the bearing portion 232 and the connection surface 211c. Thus, the light-blocking member 24 may further be located in the gap between the bottom of the bearing portion 232 and the connection surface 211c, so as to fill the gap and absorb the light emitted to the bottom of the bearing portion 232 and the connection surface 211c.

As illustrated in FIG. 3, the light-blocking member 24 is provided between the groove wall of the first step groove 211a and the engaging portion 231, between the bearing portion 232 and the second step groove 211b, and between the bottom of the bearing portion 232 and the connection surface 211c, simultaneously. In this way, the light-blocking effect between the cover plate 23 and the light-transmitting window 211 is fine.

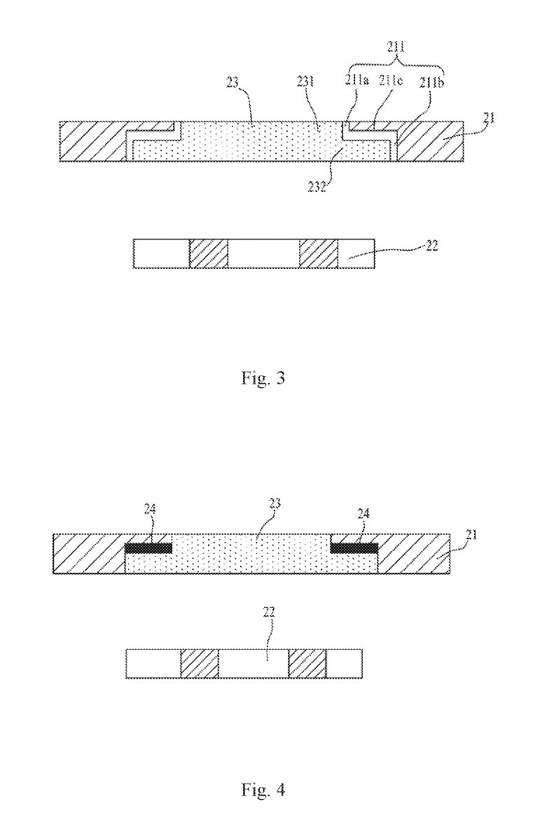

As illustrated in FIG. 4, the light-blocking member 24 is provided between the bottom of the bearing portion 232 and the connection surface 211c. That is to say, the engaging portion 231 and the first step groove 211a are gaplessly connected to each other, and the bearing portion 232 and the second step groove 211b are also gaplessly connected to each other. In this way, the light-blocking effect between the cover plate 23 and the light-transmitting window 211 is also fine.

In the laser ranging device 200 according to the second implementation of the present disclosure, the light transmitting window 211 is configured to be the stepped groove, the cover plate 23 includes the engagement portion 231 and the bearing portion 232 which are arranged up and down, the engagement portion 231 is embedded in the first step groove 211a of the light-transmitting window 211, the bearing portion 232 is embedded in the second step groove 211b of the light-transmitting window 211, and the bottom of the bearing portion 232 is configured to be parallel with the connection surface 211c of the light-transmitting window 211, thereby being capable of arranging the light-blocking member 24 between the groove wall of the first step groove 211a and the engaging portion 231, between the bearing portion 232 and the second step groove 211b, or between the bottom of the bearing portion 232 and the connection surface 211c, or arranging the light-blocking member 24 between the groove wall of the first step groove 211a and the engaging portion 231, between the bearing portion 232 and the second step groove 211b, and between the bottom of the bearing portion 232 and the connection surface 211c, simultaneously, thereby being capable of filling the gap between the cover plate 23 and the light-transmitting window 211, and absorbing the light emitted into the gap, preventing the light beam from being reflected to the light receiver to cause interference for the ranging, ensuring the accuracy of the ranging result.

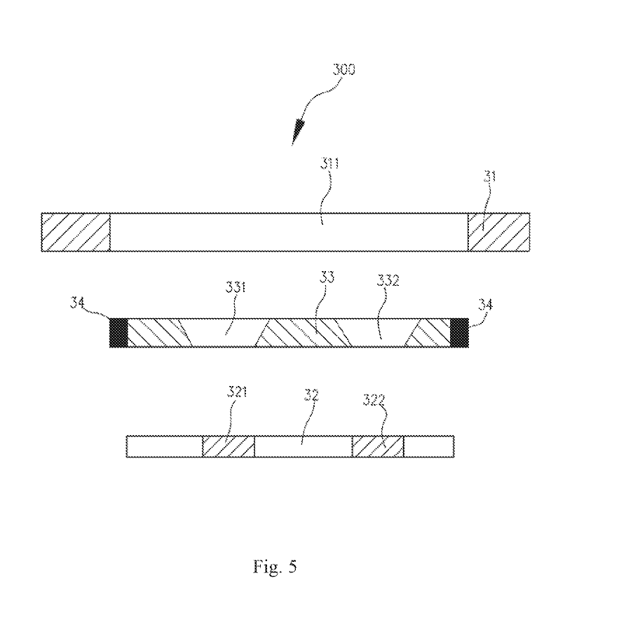

FIG. 5 is a schematic view of a laser ranging device 300 according to a third implementation of the present disclosure. The laser ranging device 300 includes a housing 31, a laser ranging sensor 32 provided in the housing 31, and a cover plate 33. The housing 31 is provided with a light-transmitting window 311. The cover plate 33 is embedded in the light-transmitting window 311, and a light-blocking member 34 is provided between the cover plate 33 and the light-transmitting window 311.

The laser ranging device 300 according to the third implementation of the present disclosure differs from the laser ranging device 100 according to the first implementation of the present disclosure in the following.

The light-blocking member 34 is an ink film or an oxide film covering the periphery of the cover plate 33. Due to the light-blocking property of the ink film or the oxide film, the light emitted to the periphery of the cover plate 33 is blocked so as to prevent the light from being reflected by the periphery of the cover plate 33. In this implementation, the light-blocking member 34 may typically be a black ink film or a black oxide film, so that the light-blocking effect can be further ensured. Typically, when the light-blocking member 34 is the ink film, the light-blocking member 34 may be provided on the periphery of the cover plate 33 by means of coating or attaching. When the light-blocking member 34 is the oxide film, the light-blocking member 34 may be a metal sheet or a metal gasket attached to the periphery of the cover plate 33, and then the metal sheet or the metal gasket may be oxidized, so as to form the oxide film.

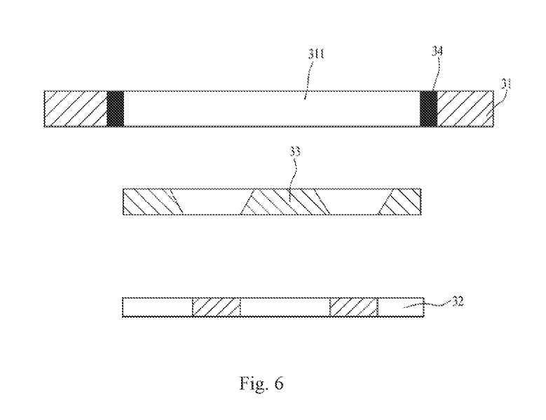

Naturally, it is should be understood that, as illustrated in FIG. 6, the light-blocking member 34 may further be an ink film or an oxide film covering the interior wall of the light-transmitting window 311. The light-blocking member 34 covers the interior wall of the light-transmitting window 311, thereby be capable of blocking the light emitted to the interior wall of the light-transmitting window 311, and in turn preventing the light from being reflected by the interior wall of the light-transmitting window 311. The way in which the light-blocking member 34 is provided on the interior wall of the light-transmitting window 311 is identical with that in which the light-blocking member 34 is provided on the periphery of the cover plate 33, and is not described again herein.

It should be understood that, the cover plate 33 may further include a first light-transmitting portion 331 and a second light-transmitting portion 332. The first light-transmitting portion 331 is provided opposite to the light emitter 321 of the laser ranging sensor 32. The second light-transmitting portion 332 is provided opposite to the light receiver 322 of the laser ranging sensor 32. The light emitter 321 emits the light beam to the detected object through the first light-transmitting portion 331, and the light beam is reflected to the light receiver 322 through the second light-transmitting portion 332 by the detected object and is received by the light receiver 322.

In the laser ranging device 300 according to the third implementation of the present disclosure, the light-blocking member 34 is provided on the periphery of the cover plate 33, thereby being capable of blocking the light emitted to the periphery of the cover plate 33, preventing the light from being reflected to the light receiver of the laser ranging sensor 32, further preventing crosstalk generated by the light, and ensuring the accuracy of the measurement result of the laser ranging device 300. In addition, when the cover plate 33 is embedded in the light-transmitting window 311, the light-blocking member 34 can also facilitate filling the gap between the cover plate 33 and the light-transmitting window 311, thereby preventing external water or dust from entering the inside of the housing 31 through the gap and ensuring the waterproof and dustproof performance of the laser ranging device 300.

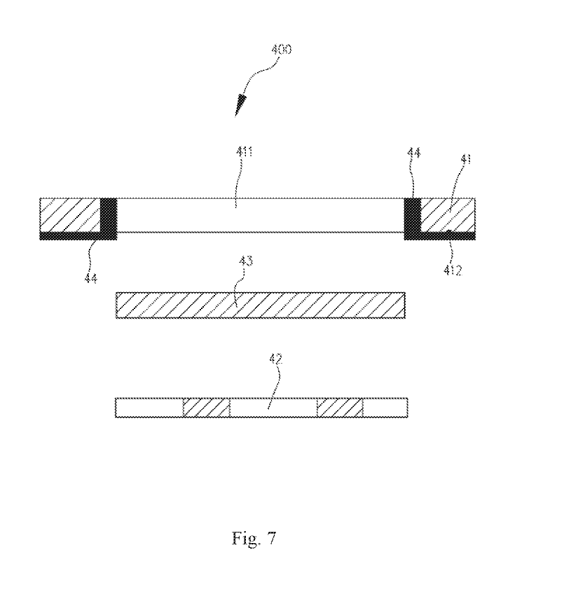

FIG. 7 is a laser ranging device 400 according to a fourth implementation of the present disclosure including a housing 41, a laser ranging sensor 42 provided in the housing 41, and a cover plate 43. The housing 41 is provided with a window 411. The cover plate 43 is mounted in the light-transmitting window 411, and the cover plate 43 seals the light-transmitting window 411. A light-blocking member 44 is provided between the cover plate 43 and the light-transmitting window 411.

The laser ranging device 400 according to the fourth implementation of the present disclosure differs from the laser ranging device 100 according to the first implementation in the following.

The housing 41 further includes an inner surface 412 facing the laser ranging sensor 42, and the light-blocking member 44 is provided on the inner surface 412. In this implementation, since the inner surface of the housing 41 is provided toward the laser ranging sensor 42, the light may be readily reflected to the light receiver of the laser ranging sensor 42 by the inner surface 412, when the light is emitted to the inner surface 412. Thus, the light-blocking member 44 is provided on the inner surface 412, and due to the light-blocking property of the light-blocking member 44, the light emitted to the inner surface 412 can be blocked, thereby preventing the light from being reflected to the light receiver. Typically, the light-blocking member 44 may be a light-blocking gasket, a light-blocking seal, a light-absorbing adhesive, an ink film, or an oxide film.

In addition, in order to further ensure the light-blocking effect, the light-blocking member 44 may also be provided on the interior wall of the light-transmitting window 411 simultaneously, thereby being capable of further preventing the interior wall of the light-transmitting window 411 from reflecting the light, rendering the connection of the cover plate 43 and the light-transmitting window 411 more tight, and in turn rendering the waterproof and dustproof performance of the laser ranging device 400 finer.

It should be understood that, when the light-blocking member 44 is an oxide layer provided on the inner surface 412 and in the light-transmitting window 411, the inner surface 412 may be oxidized to form the oxide layer, i.e., the light-blocking member 44, due to the metal material of the housing 41.

In the laser ranging device 400 according to the fourth implementation of the present disclosure, the light-blocking member 44 is provided on the inner surface 412 of the housing 41 and the interior wall of the light-transmitting window 411, thereby being capable of preventing the light being reflected by the two positions. The accuracy of the ranging result of the laser ranging device 400 is ensured.

Additionally, the present disclosure further provides an image-capturing apparatus (not illustrated) including the foregoing laser ranging device. The image-capturing apparatus includes a camera assembly (not illustrated), a processor (not illustrated), and the foregoing laser ranging device. The processor is electrically connected to the camera assembly. The laser ranging device is electrically connected to the processor. The laser ranging device sends a measurement result to the processor. The processor feeds the measurement result back to the camera assembly such that the camera assembly receives the measurement result and performs focusing for capturing images.

In the implementation of the present disclosure, the image-capturing apparatus may be a camera or a monitor or the like. When the laser beam is emitted by the laser ranging sensor of the laser ranging device, the light beam can be reflected to the detected object through the light-transmitting window, and the light beam can be reflected by the detected object, thereby obtaining the measurement result. The processor processes the measurement result and feeds the measurement result back to the camera assembly, thereby achieving a purpose that the focusing speed of the camera is increased when the camera is capturing images, and in turn having a better image-capturing experience.

On the other hand, the present disclosure further provides a terminal (not illustrated) including the foregoing laser ranging device. The terminal includes a main board (not illustrated) and the foregoing laser ranging device. The main board is provided in the housing of the laser ranging device, and the laser ranging sensor of the laser ranging device is electrically connected to the main board.

In this implementation, the terminal may be, but is not limited to, a mobile phone, a laptop PC, a tablet PC, and the like. When the laser beam is emitted by the laser ranging sensor of the laser ranging device, the light beam can be reflected to the detected object through the light-transmitting window, and the light beam can be reflected by the detected object, thereby obtaining the measurement result and in turn enabling the ranging function of the terminal.

According to the laser light-intercepting device, the image-capturing apparatus, and the terminal according to the present disclosure, the light-blocking member is provided between the cover plate and the light-transmitting window, and the light emitted from the light emitter to the edge of the cover plate or the inner surface of the housing can be blocked by the light-blocking member, thereby preventing the light from being directly reflected to the light receiver by the edge of the cover plate or the inner surface of the housing and from being absorbed by the light receiver to cause crosstalk for the emission and receipt of the infrared light, and ensuring the accuracy of the result of the laser ranging sensor measuring the target distance.

In the description of the specification, description of reference terms, such as “one implementation”, “some implementations”, “example”, “embodiment”, “some examples”, “first implementation”, or the like is intended to mean that specific features, structures, materials, or characteristics described in conjunction of the implementation or example are included in at least one implementation or example of the present disclosure. In this specification, the exemplary description of the above-mentioned terms does not necessarily refer to the same implementations or examples. Moreover, the described specific features, structures, materials, or characteristics may be combined appropriately in any one or more implementations or examples.

The foregoing is the typical implementations of the present disclosure. It should be noted that, for persons skilled in the art, several improvements and modifications can be made without departing from the principles of the present disclosure, and these improvements and modifications also fall within the protection scope of the present disclosure.

1. A laser ranging device, wherein the laser ranging device comprises a housing, a laser ranging sensor, and a cover plate, the housing is provided with a light-transmitting window, the laser ranging sensor is mounted in the housing, a light emitter and a light receiver are provided separately in the laser ranging sensor, the light emitter emits a light beam to the detected object through the light-transmitting window, the light beam is reflected to the light receiver through the light-transmitting window by the detected object and is received by the light receiver, the cover plate is embedded in the light-transmitting window, and a light-blocking member is provided between the cover plate and the light-transmitting window.

2. The laser ranging device of claim 1, wherein the cover plate comprises an engaging portion and a bearing portion which are arranged up and down, the light-transmitting window is a stepped groove formed in the housing and comprises a first step groove, a second step groove, and a connection surface connected between the first step groove and the second step groove, the engaging portion is embedded in the first step groove, the bearing portion is embedded in the second step groove, the bottom of the bearing portion is configured to be parallel with the connection surface, and the light-blocking member is located in a gap between the bottom of the bearing portion and the connection surface.

3. The laser ranging device of claim 2, wherein the light-blocking member is located in a gap between the groove wall of the first step groove and the engaging portion.

4. The laser ranging device of claim 2, wherein the light-blocking member is located in a gap between the groove wall of the second step groove and the bearing portion.

5. The laser ranging device of claim 1, wherein the light-blocking member is provided on an inner surface of the housing facing the laser ranging sensor.

6. The laser ranging device of claim 1, wherein the light-blocking member is a light-blocking gasket, a light-blocking seal, or a light-absorbing adhesive.

7. The laser ranging device of claim 1, wherein the light-blocking member is an ink film or an oxide film covering the periphery of the cover plate.

8. The laser ranging device of claim 1, wherein the light-blocking member is an ink film or an oxide film covering the interior wall of the light-transmitting window.

9. An image-capturing apparatus, wherein the image-capturing apparatus comprises a camera assembly, a processor, and the laser ranging device of claim 1, the processor is electrically connected to the camera assembly, the laser ranging device is electrically connected to the processor, the laser ranging device sends a measurement result to the processor, the processor feeds the measurement result back to the camera assembly such that the camera assembly receives the measurement result and performs focusing for capturing images.

10. A terminal, wherein the terminal comprises a main board and the laser ranging device of claim 1, the main board is provided in the housing of the laser ranging device, and the laser ranging sensor of the laser ranging device is electrically connected to the main board.

11. The image-capturing apparatus of claim 9, wherein the cover plate comprises an engaging portion and a bearing portion which are arranged up and down, the light-transmitting window is a stepped groove formed in the housing and comprises a first step groove, a second step groove, and a connection surface connected between the first step groove and the second step groove, the engaging portion is embedded in the first step groove, the bearing portion is embedded in the second step groove, the bottom of the bearing portion is configured to be parallel with the connection surface, and the light-blocking member is located in a gap between the bottom of the bearing portion and the connection surface.

12. The image-capturing apparatus of claim 11, wherein the light-blocking member is located in a gap between the groove wall of the first step groove and the engaging portion.

13. The image-capturing apparatus of claim 11, wherein the light-blocking member is located in a gap between the groove wall of the second step groove and the bearing portion.

14. The image-capturing apparatus of claim 9, wherein the light-blocking member is provided on an inner surface of the housing facing the laser ranging sensor.

15. The image-capturing apparatus of claim 9, wherein the light-blocking member is a light-blocking gasket, a light-blocking seal, or a light-absorbing adhesive.

16. The image-capturing apparatus of claim 9, wherein the light-blocking member is an ink film or an oxide film covering the periphery of the cover plate.

17. The image-capturing apparatus of claim 9, wherein the light-blocking member is an ink film or an oxide film covering the interior wall of the light-transmitting window.

18. The terminal of claim 10, wherein the cover plate comprises an engaging portion and a bearing portion which are arranged up and down, the light-transmitting window is a stepped groove formed in the housing and comprises a first step groove, a second step groove, and a connection surface connected between the first step groove and the second step groove, the engaging portion is embedded in the first step groove, the bearing portion is embedded in the second step groove, the bottom of the bearing portion is configured to be parallel with the connection surface, and the light-blocking member is located in a gap between the bottom of the bearing portion and the connection surface.

19. The terminal of claim 18, wherein the light-blocking member is located in a gap between the groove wall of the first step groove and the engaging portion.

20. The terminal of claim 18, wherein the light-blocking member is located in a gap between the groove wall of the second step groove and the bearing portion.
